(19) United States
(12) Patent Application Publication
(10) Pub. No.: US 2008/0206129 A1
(43) Pub. Date: Aug. 28, 2008

(54) Methods for transforming compounds using a metal alloy and related apparatus

(75) Inventors: Alexandr Ivanovich Vygonyaylo, Lisichansk (UA); Alec Y. Fesenko, Atlanta, GA (US)

Correspondence Address: FOLEY AND LARDNER LLP;SUITE 500, 3000 K STREET NW, WASHINGTON, DC, 20007, US

(73) Assignee: Fairstock Technologies Corporation

(21) Appl. No.: 12/007,803

(22) Filed: Jan. 15, 2008

Related U.S. Application Data
(60) Provisional application No. 60/885,082, filed on Jan. 16, 2007.

(51) Int. Cl. C01B 6/00; B01J 19/00

(52) U.S. Cl. 423/645; 423/659; 422/129

(57) ABSTRACT

A compound, such as an organic compound, can be transformed utilizing a melted metal alloy by generating an energy gradient in a system that includes the compound and the alloy. Accordingly, provided are methods for transforming compounds and related apparatuses.

### CROSS-REFERENCE TO RELATED PATENT APPLICATIONS

The present application claims benefit of U.S. provisional application 60/885,082, filed Jan. 16, 2007, which is incorporated herein by reference in its entirety.

### FIELD

The present invention relates to methods and apparatuses for transforming compounds and more specifically methods and apparatuses for transforming compounds utilizing a melted metal alloy.

### BACKGROUND

Natural gas is a major source of methane. Other sources of methane have been considered for fuel supply, e.g., the methane present in coal deposits or formed during mining operations. Relatively small amounts of methane are also produced in various petroleum processes.

The composition of natural gas at the wellhead varies, but its major hydrocarbon is methane. For example, the methane content of natural gas may vary within the range from about 40 to about 95 volume percent. Other constituents of natural gas include ethane, propane, butanes, pentane (and heavier hydrocarbons), hydrogen sulfide, carbon dioxide, helium and nitrogen.

Natural gas is classified as dry or wet depending upon the amount of condensable hydrocarbons that is contains. Condensable hydrocarbons generally comprise hydrocarbons having 3 or more carbon atoms, although some ethane may be included. Gas conditioning is required to alter the composition of wellhead gas, with processing facilities usually being located in or near the production fields. Conventional processing of wellhead natural gas yields processed natural gas containing at least a major amount of methane.

Large scale use of natural gas often requires a sophisticated and extensive pipeline system. Liquefaction has also been employed as a transportation means, but processes for liquefying, transporting, and revaporizing natural gas are complex, energy-intensive and require extensive safety precautions. Transport of natural gas has been a continuing problem in the exploitation of natural gas resources. It would be extremely valuable to be able to convert methane (e.g., natural gas) to more readily handleable or transportable products. Moreover, direct conversion to olefins, such as ethylene or propylene would be extremely valuable to the chemical industry.

A common method for methane conversion is steam methane reforming performed at a high temperature of 600° C. to 840° C. at a high pressure of about 5 to 100 atmospheres in the presence of nickel or other metal based catalyst. The disadvantages of the steam methane reforming include the use of the catalyst, high pressure and temperature, which a) are costly to produce and b) require a sturdy reaction apparatus, and low yield.

U.S. Pat. No. 5,093,542 discloses an alternative method of methane conversion, in which a gas containing methane and a gaseous oxidant is contacted with a non-acidic catalyst at temperatures within the range of about 700° to 1200° C. in the presence of a halogen promoter and in the substantial absence of alkali metals or their compounds.

U.S. Pat. No. 4,962,261 discloses another alternative method of methane conversion to higher molecular weight hydrocarbons in a process using a catalyst containing boron, tin and zinc at temperatures ranging from 500 to 1000° C.

US 2004/0120887, US 2005/0045467, US 2003/0182862, U.S. Pat. No. 6,413,491 and GB 2,265,382 disclose other alternative methods of methane conversion.

Still, a need exists to develop low temperature methods for transforming methane and other organic compounds that do not necessarily require a metal catalyst.

### SUMMARY

In one embodiment, the invention provides a method comprising providing a melted metal alloy; providing at least one compound comprising hydrogen; and generating an energy gradient in a system comprising the alloy and the at least one compound, wherein said generating results in redistributing the hydrogen in the at least one compound.

In another embodiment, the invention provides an apparatus comprising (i) a metal alloy comprising a first component that is a metal of the 5^{th} period of the Periodic Table and a second component that is an element having an atomic number higher than 79; (ii) a vessel adapted to provide at least one compound; and (iii) at least one energy source configured for generating an energy gradient in a system comprising the metal alloy and the at least one compound.

In yet another embodiment, the invention provides an apparatus comprising a metal alloy comprising a first component that is a metal of the 5^{th} period of the Periodic Table and a second component that is an element having an atomic number higher than 79; means for providing at least one compound comprising hydrogen; and means for generating an energy gradient in a system comprising the metal alloy and the at least one compound.

And in yet another embodiment, the invention provides a method for converting heavy hydrocarbons into light hydrocarbons, comprising (i) providing a melted metal alloy; (ii) providing a raw material comprising heavy hydrocarbons; and (iii) generating an energy gradient in a system comprising the metal alloy and the raw material, wherein the generating results in converting of the heavy hydrocarbons into light hydrocarbons.

And in yet another embodiment, the invention provides a method of transforming at least one compound, comprising providing the at least one compound; providing a metal alloy comprising a first component that is a metal of the 5^{th} period of the Periodic Table and a second component that is an element having an atomic number higher than 79; and generating an energy gradient in a system comprising the metal alloy and the at least one compound to transform the at least one compound.

### DRAWINGS

FIG. 1 schematically illustrates an apparatus with a spiral pipe.

FIG. 2A schematically illustrates a three stage apparatus.

FIG. 2B schematically illustrates a pipe with conical working bodies.

### DETAILED DESCRIPTION

Unless otherwise specified “a” or “an” means one or more.

### Related Applications

The present application incorporates by reference in their entirety the following applications:

1) Ukrainian Patent Application No. a200509452 filed Oct. 10, 2005, published as a publication No. UA 74,762 C2 on Jan. 16, 2006;
2) Ukrainian Patent Application No. a200509544 filed Oct. 11, 2005, published as a publication No. UA 74,763 C2 on Jan. 16, 2006;
3) PCT Patent Application No. PCT/US2006/039269 filed Oct. 10, 2006.

The inventors have discovered that creating an energy gradient, such as a temperature gradient, in a system that includes a compound and a melted metal alloy can be used for transforming the compound. The transformation of the compound can occur without contacting the compound with a metal catalyst and without directly exposing the compound to high temperatures. For example, in some embodiments, the transformation can be performed without exposing the compound to a temperature above 500° C. Yet in some embodiments, the transformation can be performed without exposing the compound to a temperature above 380° C. In some embodiments, the transformation of the compound can occur without exposing the compound to an excessive pressure above the atmospheric pressure.

### Metal Alloy

The metal alloy can be a metal alloy with a low melting temperature. For instance, the melting temperature of the alloy can be below 200° C. or below 150° C. The melting temperature can be either a liquidus temperature of the alloy or a solidus temperature of the alloy.

The metal alloy can be an alloy comprising one or more metals selected from metals of the 5th period of the periodic table, such as Rb, Sr, Y, Zr, Nb, Mo, Tc, Ru, Rh, Pd, Ag, Cd, In, Sn, Sb, Te, and I, and metals having an atomic number higher than 79, such as Hg, Tl, Pb and Bi. Preferably, the metal alloy does not comprise radioactive isotopes. Preferably, the metal alloy comprises a first component that is one or metals of the 5^{th} period of the periodic table and a second component that is one or more metals having an atomic number ranging from 80 to 83.

Preferably, the first component and the second component of the alloy have an average molecular weight equal of about 157. For example, when the first component is Sn, and the second component is Bi, a Bi:Sn atomic ratio in the alloy should be approximately 42.4:57.6.

In some embodiments, the metal alloy can comprise Bi and Sn. Examples of such alloys include Wood's alloy (50% Bi, 13.3% Sn, 26.7% Pb, 10% Cd), which has a melting temperature around 70° C. and Rose's alloy (50% Bi, 25% Sn, 25% Pb), which has a melting temperature around 100° C.

In some embodiments, the alloy that includes Sn, as the first component, and Bi, as the second component, can comprise additional elements such as Al, Fe, Sb or a combination thereof. One non-limiting example of such alloy can be an alloy having a Bi:Sn:Sb:Al:Fe atomic ratio approximately 37.2272:50.2728:12:0.1:0.1.

In some embodiment, the alloy can an average molecular weight can of about 179. Such an alloy can comprise Bi, Sn, Al, Fe and Sb.

The metal alloy used for the transformation of the compounds can be a non-eutectic alloy. In such embodiment, the melted or liquefied alloy can be in a multiphase liquid plus solid form.

In some embodiments, the melted alloy can be heated to a temperature above 60° C. Yet in some embodiments, the metal alloy can be heated to a temperature of about 80 to 175° C.

### Compound

The compound that can be transformed according to the present invention can be any compound that includes an atom having a spherical symmetry of charge. For instance, the compound can be a compound that comprises a hydrogen atom. The compound can be, for example, an organic compound. In some embodiments, the organic compound can be a compound having a C—H bond. Examples of such compounds are hydrocarbon molecules, such as alkanes or cycloalkanes.

In some embodiments, the organic compounds to be transformed can include an organic compound that has at least one heteroatom different from C. Such a heteroatom can be, for example, N, O or S.

The transformation or conversion of the compound means that, as a the result of the generation of an energy gradient, one or more products that have a chemical structure different from the starting compound are formed. The transformation can be direct or indirect, i.e. it can be a direct or indirect result of generated energy gradient. For example, the transformation of hydrocarbons, such as alkanes or cycloalkanes, can involve their decomposition into products that comprise hydrogen as a direct result of the generated energy gradient. The products of the direct transformation can be used for transforming one or more additional compounds. For example, free hydrogen formed in the hydrocarbon transformation can be used for transforming a substituted nitrocompound into a substituted aminocompound. Such a transformation is an example of the indirect transformation.

In some embodiments, the generated energy gradient can be used for transformation of a raw material comprising hydrocarbons, such as raw oil or natural gas. In such embodiment, the transformation of the raw material can result in an increase of a percentage of lighter hydrocarbon fractions in the transformation products compared to the raw material. In some embodiments, the lighter hydrocarbon fractions can be hydrocarbons having boiling temperature below about 210° C., yet in some embodiments, the lighter hydrocarbons can be hydrocarbons having boiling temperature below about 360° C. The percentage of light hydrocarbon fractions can be increased by at least 1.5 times or by at least 1.8 times or by at least 2 times.

The products of the raw hydrocarbon material transformation can have a molecular weight different that the starting hydrocarbons. The products can comprise hydrocarbons having a molecular weight lighter than the starting raw material and enriched with hydrogen hydrocarbons having a molecular weight heavier than the starting raw material. To separate the light fraction from the heavy one, the former can be evaporated and then condensed using an appropriate cooling system in a separate volume. The heavy fraction can be removed from an area of exposure to the heat flow in a liquid state.

In some embodiments, the generated energy gradient can be used for transformation at least one compound comprising hydrogen. As the result of such transformation, the products have hydrogen redistributed compared to the original compound. In some embodiments, hydrogen redistribution can be manifested by a production of molecular hydrogen as the result of the transformation. Yet in some embodiments, hydrogen redistribution can be manifested that in transformation products that are enriched in hydrogen compared to the original compound and in transformation products that have a lower hydrogen content compared to the original compound. For example, for hydrocarbon transformation, the transformation products can include products that have higher H:C ratio than the original compound and products that have lower H:C ratio than the original compound.

In some embodiments, the generated energy gradient can be used for a transformation of heavy hydrocarbons into light hydrocarbons. In such a case, the original hydrocarbons can have a higher molecular weight than products of the original hydrocarbons' transformation.

In some embodiments, one or more compounds to be transformed can be provided in a zone of exposure to a heat flow that passed through the metal alloy together with ballast materials that can increase a heat and mass transfer. The ballast materials can be metals, ceramics or other inert materials that do not react with the compounds to be transformed. Preferably, the ballast materials do not change a viscosity of the one or more compounds.

In some embodiments, the compound to transformed can be in a liquid state. An example of such liquid compound can be a raw oil. Yet in some embodiment, the compound to be transformed can be is a gaseous state. An example of such gaseous compound can be a natural gas.

### Generating Energy Gradient

Generating an energy gradient in a system, that includes the metal alloy and the compound to be transformed, can be accomplished in a number of ways. In some embodiments, the energy gradient can be generated by exposing the compound to an energy flow that passed through the melted metal alloy. Such an energy flow can be, for example, a heat flow, a light, or a combination thereof. For example, in some embodiment, the melted metal alloy can be in a thermal contact with a heat source, such as a resistance heater, a heater lamp, a radio frequency heating coil, etc., and a heat flow passing through the melted metal alloy can be used for transforming the metal alloy. In some embodiments, the energy gradient can be generated by a light illuminating the metal alloy and/or the compound to be transformed. A source of the light can be, for example, a laser or a lamp. In some embodiments, the light source can be a light source with a wavelength around 598 nm.

In some embodiments, the energy gradient can be a temperature gradient between the metal alloy and the compound to be transformed. In some embodiments, the temperature gradient can be such that the metal alloy has or is exposed to a temperature higher than a temperature of the compound to be transformed. Yet in some embodiments, the temperature gradient can be such that a temperature of the compound is higher than a temperature of the metal alloy.

In some embodiments, the energy gradient can be a temperature gradient within the metal alloy. For example, one part of the metal alloy can be exposed to a temperature higher than another part of the metal alloy.

In some embodiments, to generate the energy gradient, the metal alloy can be exposed to a temperature ranging from 60° C. to 450° C. or from 80 to 400° C. or from 80 to 175° C. or from 300° C. to 450° C. or from 320° C. to 400° C. or from 360° C. to 410° C.

In some embodiments, the energy gradient can be generated by preheating the compound to an elevated temperature and exposing the metal alloy to a flow of the preheated compound. For example, the compound can be preheated to a temperature ranging from 80 to 360° C. or from 80 to 175° C. or from 140 to 360° C.

Although the present invention is not limited in any aspect by its theory, the inventor hypothesizes that the generated energy gradient can lead to a second order phase transition in the metal alloy. After undergoing such a transition the metal alloy may produce a field having a spherical symmetry. Such a field of spherical symmetry may affect a charge having a spherical symmetry in the compound to be transformed, such as a charge of 1s electron in a hydrogen atom.

### Apparatus

The apparatus for transforming a compound can include the melted metal alloy, a device for passing the compound and an energy source configured to create an energy gradient in a system that includes the compound and the melted alloy and the energy source.

The device for passing the compound can be, for example, a vessel, a conduit or a chamber. In some embodiments, the device can have an inlet for supplying one or more compounds to be transformed and an outlet for removing the products of the transformation. In some embodiments, the vessel for passing the compound can be a pipe. In some embodiments, the pipe can be a straight pipe, yet in some embodiments, the pipe can be a curved pipe, i.e. a pipe having one or more curves or bends. Such a curved pipe can be a zigzagged pipe or a spiral pipe. The additional curvature of the pipe can be used for maximizing the exposure of the compound passing through the pipe to the heat flow. In some embodiments, the device for passing the compound can be immersed in the melted metal alloy.

In some embodiments, the melted metal alloy and the compound to be transformed are not in direct physical contact. For example, the compound passing the device can be separated from the metal alloy by a wall. In some embodiments, such a wall can be a wall of the device for passing the compound. Yet in some embodiment, such a wall can be a wall of a working device discussed in more details below. Preferably, the wall separating the metal alloy and the compound is a non-ferromagnetic wall, i.e. the wall does not comprise materials that are permanent magnets. In some embodiments, the wall comprise a non-ferromagnetic material such as steel, copper or copper alloys, such as brass. Preferably, the material of the wall is a good heat conductor, i.e. have a thermal conductivity higher than 10 W/(m*K) or higher than 20 W/(m*K) or higher than 50 W/(m*K). The separating wall can have any thickness, however, in some embodiments, a wall ranging from 0.1 to 10 mm may be preferred.

In some embodiments, the apparatus can comprise an inner pipe inside an outer pipe. In such embodiment, the metal alloy can be disposed in the space between the inner and outer pipes. The compound to be transformed can be passing through the inner pipe. The apparatus comprising the inner pipe and the outer pipe can act as a pipe within pipe, i.e. a coaxial pipe, heat exchanger.

In some embodiments, the apparatus can comprise at least one working body. Such a working body can be placed in a path of the compound to be transformed in the vessel or conduit. The working body can be an hollow object with a curved outer surface. For example, a working body can have a spherical, cylindrical or a conical shape. The spherical shape can be preferable in certain embodiments. The inner reservoir of the working body can be filled with the melted metal alloy. The metal alloy can fill at least 30% or at least 50% of a volume of the inner reservoir. Preferably, the metal alloy fills from about 65% to about 75% of the volume of the inner reservoir.

The working body can be produced by any convenient method such as cutting, pressing, welding etc. The walls of the working body separating the metal alloy and the compound to be transformed can be made of any non-ferromagnetic material. Placing the working body in a path of the preheated compound in the passing device can result in generating an energy gradient in a system that includes the metal alloy in the working body and the preheated compound. Such a gradient can result in a transformation of the preheated compound.

In some embodiments, the apparatus can include one or more turbilizing attachments, i.e. attachments that can create a turbulence in a flow of the compound to be transformed. Such turbilizing attachments can be, for example, one or more inverse cones, a nozzle or a diaphragm. The turbilizing attachments can be used to create a cavitation in the flow of the compound to be transformed.

In some embodiments, multiple turbilizing attachments can be placed in series in a path of the compound to be transformed in the passing device. In some embodiments, the turbilizing attachment can be used for turbilizing per se, yet in some embodiments, the turbilizing attachment can also act as a working body described above, i.e. contain the melted metal alloy.

The energy source can be any energy source that can lead to generation of an energy gradient in a system that includes the metal alloy and the compound to be transformed. The energy source can be, for example, a heat source, a light source or a combination thereof. Examples of heat sources include, but not limited to, a resistance heater, a heater lamp, a radio frequency heating coil, etc. In some embodiments, the heat source can be a jacket surrounding the device for passing the compound to be transformed. Such a jacket can be heated with gases having an elevated temperature, such as burner gases. In some embodiments, the heat source can be in a direct thermal contact with the metal alloy. Yet in some embodiments, the heat source can be configured to up the compound to be transformed prior to the compound's entrance to the device for passing the compound.

In some embodiments, the device for passing the compound can include heat exchange and/or mass exchange facilitating attachments. In some embodiments, such attachments can be spherical in shape, yet in some embodiments, can be made of pipes forming bundles or plates. Materials for such attachments can be, for example, metals or ceramics, preferably inert, i.e. not interacting with the compound to be transformed. In some embodiments, the exchange device can be used for heat/mass exchange per se, yet in some embodiments, the exchange device can be also a working body, i.e. it can contain the metal alloy.

The heat source can have an intensity depending on a size of the apparatus.

In some embodiments, the heat source can have an intensity ranging from 20 kW/m² to 70 kW/m². Yet in some embodiments, the heat source can have an intensity of at least 30 kW/m². And yet in some embodiments, the heat source can have an intensity of at least 35 kW/m².

In some embodiments, the apparatus can comprise a stirrer immersed in the metal alloy. Such a stirrer can be an anchor stirrer or a nozzle equipped impeller.

In some embodiments, the apparatus can further comprise a cooling system coupled to the device for passing the compound. The cooling system can be used for condensing an evaporated fraction of transformation products.

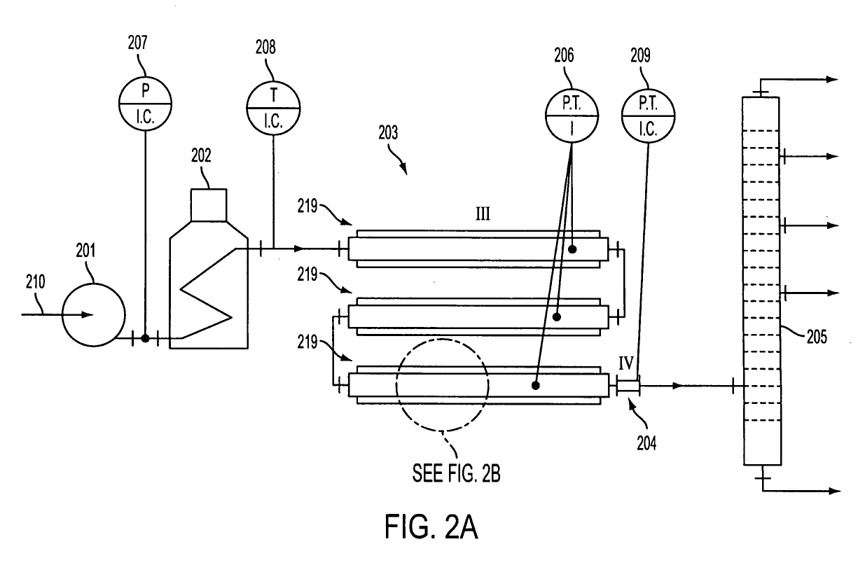

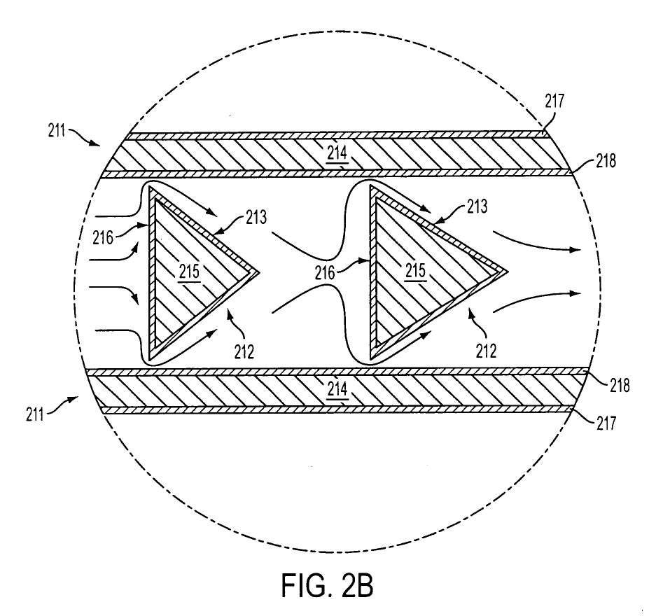

FIG. 2A illustrates one embodiment of the apparatus. The apparatus in FIG. 2A includes a pump 201, a raw material heater 202, a reactor 203, a throttle 204 and a pipeline feeding column 205. The pump 201 can be used for creating a pressure in the raw material heater 202 and the reactor 203. The additional pressure in the raw material heater can be used for suppressing evaporation of the raw material. Such evaporation can decrease an efficiency of the heater and reduce a heat exchange. After the reactor 3, the pressure can be lowered in the throttle 204 to a level of the pressure in a pipeline feeding column 205.

Although the reactor 203 illustrated in FIG. 2A has three stages, the reactor can have more or less stages if necessary. For example, in some cases, the reactor can have from 1 to 6 stages. Each of the stages 219 of the reactor 203 may be equipped with temperature and pressure controlling devices 206. A device for pressure controlling 207 may be also placed at the outlet of the feeding pump 201. One or more temperature controlling and/or regulating devices 208 can be placed at the outlet of the heater 202. Also, a pressure controlling and/or regulating device 209 can be placed on the throttle 204 at the reactors outlet. The reactor 203 can have a thermal insulation which can be a thermal insulation of the same standard as a thermal isolation of a pipeline feeding the column 205.

FIG. 2B presents a cross section for one of the stages 219 of the reactor 203. Arrows indicates a direction of the raw material flow, i.e. the compound to be transformed flow. A body 211 of the reactor is formed by an outer pipe 217 and an inner pipe 218. The inverse cone working body 212 has walls 213 enclosing inner space 215. Regions 214 and/or 215 correspond to a melted metal alloy as described above in the interpipe space 214 and in the inner reservoir of the working body 212.

The inverse cone working body 212 can be placed in the reactor 203 so that a base 216 of the working body 212 forms a circular gap with the inner wall of the inner pipe 218. Such a gap can create a turbulence in the raw material flow flowing around the working body 212. A size of the gap can be varied to vary a degree of the turbulence. Alternating a laminar flow in the circular gap and a turbulent flow between the conical working bodies 212 can provide a favorable hydrodynamics in the reactor 203 as a creation and disappearance of vortices in the raw material flow can match energy gradient generation taking place in the metal alloy under the heat flow brought by the raw material.

In some embodiments, the reactor can have three stages in series with a total length of 6 m. The inner pipe's diameter can be 150 mm. In such a case, a raw material, such as a crude oil, can spend from around 6 to around 10 seconds in the reactor. Working parameters of the reactor can be as follows. A supply pressure for the raw material can range from 0.05 to 20 MPa, or from 0.1 to 10 MPa, or from 2 to 4 MPa. A supply temperature of the raw material can range from 80 to 400° C. or from 80 to 175° C. or from 140 to 370° C. or from 320 to 360° C. A volume supply rate for the raw material up to 50 m³/h or up to 40 m³/h or up to 30 m³/h. The reactor can be used for processing up to 250,000 metric tons of oil per year. For larger installations, the reactor can have different dimensions.

The invention is further illustrated by, though in no way limited to, the following examples.

### Transformation of Methane

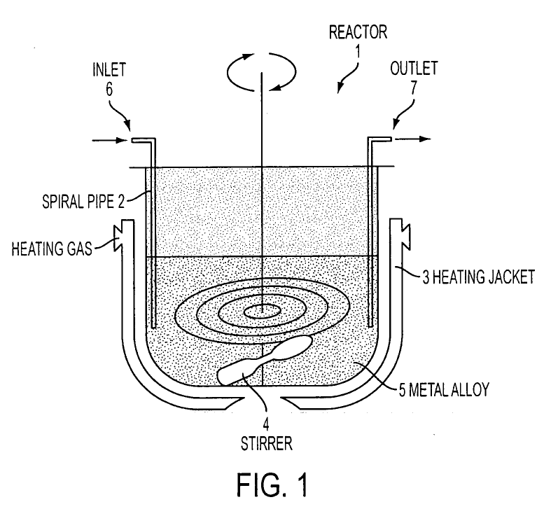

FIG. 1 schematically illustrates an apparatus for methane transformation into hydrogen and carbon. In FIG. 1, reactor vessel 1 has a volume ranging from 0.5 to 10 liters and steel walls with a thickness ranging from 0.1 to 10 mm. A spiral pipe 2 is placed at the bottom of the reactor 1. The spiral pipe 2 can be made of steel. The spiral pipe can also be made of any non-ferromagnetic material. The reactor 1 is filled with the metal alloy 5. The twisted part of the spiral pipe 2 is completely immersed in the metal alloy. A thickness of the metal alloy above the last twisted segment of the spiral pipe is preferably no less than 0.04 m. Preferably, the reactor 1 is hermetically sealed because moisture in the surrounding air can cause oxidation of the metal alloy 5. A heating gas conduit or jacket 3 is placed at the outer side of the reactor 1.

After heating up the metal alloy 5 to a temperature of 80 to 175° C. to melt the alloy, the stirrer 4 located underneath the spiral pipe 2 is turned on. The stirrer 4 can be an anchor stirrer having a frequency ranging from 60 to 120 Hz, or a nozzle equipped impeller having a frequency ranging from 150 to 300 Hz.

After letting the stirrer 4 run for approximately 15 minutes in the heated reactor 1, methane is introduced into the spiral pipe 2 through inlet 6. Methane supply rate is selected to be such that methane can pass through the spiral pipe in 0.2-12 seconds.

Although the present invention is not limited by a particular theory, heating and stirring is believed to cause an imitation of a phase transition in the metal alloy. The energy of the phase transition is believed transform methane into carbon and hydrogen (CH₄->4H+C), which are removed through pipe outlet 7.

### Transformation of Orthonitrotoluene

The apparatus depicted in FIG. 1 can be also used for transforming orthonitrotoluene into orthoaminotoluene. For performing this transformation, a mixture that includes 1.5 mole of methane per 1 mole of orthonitrotoluene is introduced in the inlet 6 of the pipe 2 after heating the metal alloy to a temperature ranging from 80 to 175° C. and stirring the metal alloy for 15 minutes. The transformation products of the mixture include 2 moles of water, 1 mole of ortho-aminotoluene and 1 mole of carbon per one mole of orthonitrotoluene in the mixture.

### Preprocessing of Crude Oil

Table 1 presents distillation results of Canadian Crude oil before and after preprocessing according to the present invention. The Canadian Crude oil was preprocessed using a reactor similar to the one presented in FIG. 1.

TABLE 1

| | Result | | |
|---|---|---|---|
| | Canadian | Canadian | |
| | Crude, no | Crude -After | |
| Test | prepocessing | preprocessing | Unit |
| Distillation Yield, 21- | 8.51 | 16.01 | Wt % |
| 210° C. | | | |
| Distillation Yield, 210- | 25.53 | 48.14 | Wt % |
| 360° C. | | | |
| Distillation Yield, 21- | 10.85 | 18.96 | LV % |
| 210° C. | | | |
| Distillation Yield, 210- | 26.87 | 49.47 | LV % |
| 360° C. | | | |

Conclusion: preprocessing according to the present invention increases a percentage of light fractions in Canadian crude oil.

Tables 2 and 3 present distillation results for West Siberian Crude Oil before and after preprocessing according the method of the present invention. The West Siberian Crude oil was preprocessed using an apparatus similar to the one presented in FIG. 1.

TABLE 2
West Siberian Crude Oil without preprocessing.

Evaporated (% mass.)

| Name of fraction, ° C. | Individual fractions | Total |
|---|---|---|
| IBP-60 | 3.8 | 3.8 |
| 60-70 | 1.4 | 5.2 |
| 70-80 | 0.9 | 6.1 |
| 80-90 | 1.5 | 7.6 |
| 90-100 | 2.8 | 10.4 |
| 100-110 | 1.6 | 12.0 |
| 110-120 | 1.7 | 13.7 |
| 120-130 | 2.3 | 16.0 |
| 130-140 | 1.6 | 17.6 |
| 140-150 | 2.4 | 20.0 |
| 150-160 | 1.6 | 21.6 |
| 160-170 | 1.8 | 23.4 |
| 170-180 | 1.0 | 24.4 |
| 180-190 | 1.1 | 25.5 |
| 190-200 | 1.8 | 27.3 |
| 200-210 | 2.8 | 30.1 |
| 210-220 | 2.4 | 32.5 |
| 220-230 | 2.3 | 34.8 |
| 230-240 | 2.0 | 36.8 |
| 240-250 | 1.8 | 38.6 |
| 250-260 | 1.4 | 40.0 |
| 260-270 | 2.0 | 42.0 |
| 270-280 | 1.9 | 43.9 |
| 280-290 | 2.5 | 46.4 |
| 290-300 | 2.1 | 48.5 |
| 300-310 | 1.8 | 50.3 |
| 310-320 | 1.6 | 51.9 |
| 320-330 | 1.9 | 53.8 |
| 330-340 | 1.0 | 54.8 |
| 340-350 | 1.4 | 56.2 |
| 350-360 | 2.3 | 58.5 |
| Residue above 360° C. | 37.7 | 96.2 |
| Gas + loss | 3.8 | 100 |

TABLE 3
West Siberian Crude Oil after preprocessing
using the method of invention.

Evaporated (% mass.)

| Name of fraction, ° C. | Individual fractions | Total |
|---|---|---|
| IBP-60 | 2.9 | 2.9 |
| 60-70 | 1.4 | 4.3 |
| 70-80 | 1.3 | 5.6 |
| 80-90 | 1.4 | 7.0 |
| 90-100 | 2.6 | 9.6 |
| 100-110 | 1.3 | 10.9 |
| 110-120 | 2.2 | 13.1 |
| 120-130 | 2.4 | 15.5 |
| 130-140 | 2.0 | 17.5 |
| 140-150 | 2.6 | 20.1 |
| 150-160 | 2.1 | 22.2 |
| 160-170 | 2.3 | 24.5 |
| 170-180 | 2.4 | 26.9 |
| 180-190 | 2.6 | 29.5 |
| 190-200 | 1.8 | 31.3 |
| 200-210 | 1.6 | 32.9 |
| 210-220 | 2.3 | 35.2 |
| 220-230 | 4.0 | 39.2 |
| 230-240 | 1.9 | 41.1 |
| 240-250 | 2.0 | 43.1 |
| 250-260 | 2.6 | 45.7 |
| 260-270 | 2.7 | 48.4 |
| 270-280 | 2.3 | 50.7 |
| 280-290 | 2.8 | 53.5 |
| 290-300 | 2.9 | 56.4 |
| 300-310 | 2.9 | 59.3 |
| 310-320 | 2.9 | 62.2 |
| 320-330 | 2.4 | 64.6 |
| 330-340 | 2.7 | 67.3 |
| 340-350 | 3.0 | 70.3 |
| 350-360 | 2.9 | 73.2 |
| Residue above 360 | 23.4 | 96.6 |
| Gas + loss | 3.4 | 100.0 |

Conclusion: preprocessing according to the present invention increases a percentage of light fractions in West Siberian crude oil.

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention.

All of the publications, patent applications and patents cited in this specification are incorporated herein by reference in their entirety.

1. A method comprising
(i) providing a melted metal alloy;
(ii) providing at least one compound comprising hydrogen;
(iii) generating an energy gradient in a system comprising the alloy and the at least one compound, wherein said generating results in redistributing the hydrogen in the at least one compound.

2. The method of claim 1, wherein the metal alloy comprises a first component that is a metal of the 5^{th} period of the Periodic Table and a second component that is an element having an atomic number higher than 79.

3. The method of claim 2, wherein an average atomic mass of the first component and the second component is approximately 157.

4. The method of claim 2, wherein the first component is Sn and the second component is Bi.

5. The method of claim 4, wherein an atomic Bi:Sn ratio in the metal alloy is 42.4:57.6.

6. The method of claim 4, wherein the metal alloy further comprises Al, Fe, Sb or a combination thereof.

7. The method of claim 6, wherein the metal alloy comprises Sn, Bi, Al, Fe and Sb and an atomic Bi:Sn:Sb:Al:Fe ratio in the alloy is 37.2272:50.2728:12:0.1:0.1.

8. The method of claim 1, wherein the at least one compound comprises at least one organic compound.

9. The method of claim 1, wherein the at least one compound comprises at least one alkane.

10. The method of claim 1, wherein the at least one compound comprises a raw hydrocarbon material.

11. The method of claim 10, wherein the raw hydrocarbon material is a raw oil.

12. The method of claim 10, wherein the generating results in a product that has a higher percentage of light hydrocarbon fractions than the at least one compound.

13. The method of claim 1, wherein the provided metal alloy and the provided at least one compound are not in direct physical contact.

14. The method of claim 13, wherein the provided metal alloy and the provided at least one compound are separated by a non-ferromagnetic wall.

15. The method of claim 1, wherein the generating does not comprise exposing the at least one compound to a metal catalyst.

16. The method of claim 1, wherein the generating results in creating a field of spherical symmetry in the metal alloy.

17. The method of claim 1, wherein the generating comprises generating a temperature gradient between the metal alloy and the at least one compound.

18. The method of claim 1, wherein the generating comprises exposing at least one of the metal alloy and the at least one compound to an electromagnetic energy.

19. The method of claim 18, wherein the generating comprises exposing at least one of the metal alloy and the at least one compound to a heat, a light or a combination thereof.

20. The method of claim 1, wherein the redistributing comprises forming from the at least one compound a molecular hydrogen and a product having a lower hydrogen content than the at least one compound.

21. An apparatus comprising
(i) a melted metal alloy comprising a first component that is a metal of the 5^{th} period of the Periodic Table and a second component that is an element having an atomic number higher than 79;
(ii) a vessel adapted to provide at least one compound; and
(iii) at least one energy source configured for generating an energy gradient in a system comprising the metal alloy and the at least one compound.

22.-67. (canceled)

68. A method of transforming at least one compound, comprising providing the at least one compound;
providing a metal alloy comprising a first component that is a metal of the 5^{th} period of the Periodic Table and a second component that is an element having an atomic number higher than 79; and
generating an energy gradient in a system comprising the metal alloy and the at least one compound to transform the at least one compound.

69.-85. (canceled)
